(19) United States
(12) Patent Application Publication
(10) Pub. No.: US 2017/0370332 A1
(43) Pub. Date: Dec. 28, 2017

(54) FUEL COOLING SYSTEM AND METHOD

(71) Applicant: Carrier Corporation, Farmington, CT (US)

(72) Inventor: Jason R. Kondrk, Clay, NY (US)

(21) Appl. No.: 15/542,210

(22) PCT Filed: Jan. 5, 2016
(86) PCT No.: PCT/US2016/012111

§ 371 Date: Jul. 7, 2017

Related U.S. Application Data
(60) Provisional application No. 62/100,529, filed on Jan. 7, 2015.

(51) Int. Cl. F02M 31/20; F25B 41/04; F25B 5/04; F25B 40/00; F25D 11/00; B60H 1/00; F28F 27/02; F25B 25/00; F28D 21/00

(52) U.S. Cl. CPC F02M 31/20; F28F 27/02; F25B 41/043; F02M 31/205; F25B 5/04; F25B 25/005; F25B 40/00; F25D 11/003; B60H 1/00271; F25B 2400/0409; F25B 2600/2501; F25B 2700/2106; B60H 2001/00307; F28D 2021/0087

(57) ABSTRACT

A fuel cooling system includes a refrigeration unit configured to circulate a refrigerant, a bypass cooling circuit (132) fluidly coupled to the refrigeration unit, and a power generation system operably coupled to the refrigeration unit. The power generation system includes a fuel tank (34) fluidly coupled to an engine (32), and a fuel cooling circuit (160) is fluidly coupled between the fuel tank and the engine. The fuel cooling circuit is thermally coupled to the bypass cooling circuit and is configured to cool a fuel by thermal exchange with the refrigerant.

### FIELD OF THE INVENTION

The subject matter disclosed herein relates to transportation refrigeration systems and, more specifically, to transportation refrigeration systems for cooling a fuel.

### BACKGROUND

Temperature controlled cargo containers, such as refrigerated trailers, are commonly used to transport food products and other temperature sensitive products. A refrigerated trailer typically includes a refrigeration unit generally mounted on the front wall of the trailer with a portion protruding into the interior of the trailer.

In some known trailers, an engine may be used to drive a compressor of the refrigeration system. Fuel for the engine may be located under the trailer and exposed to heat and ambient temperatures. Hot fuel occupies more space at less density of fuel, which may reduce engine power. Increased fuel temperature may also decrease the fuel viscosity, which may increase leakage flow past pistons during injection and allow increased unburned particulates into the atmosphere.

### BRIEF DESCRIPTION OF THE INVENTION

In one aspect, a fuel cooling system is provided. The fuel cooling system includes a refrigeration unit configured to circulate a refrigerant, a bypass cooling circuit fluidly coupled to the refrigeration unit, and a power generation system operably coupled to the refrigeration unit. The power generation system includes a fuel tank fluidly coupled to an engine, and a fuel cooling circuit is fluidly coupled between the fuel tank and the engine. The fuel cooling circuit is thermally coupled to the bypass cooling circuit and is configured to cool a fuel by thermal exchange with the refrigerant.

In addition to one or more of the features described above, or as an alternative, further embodiments may include: a container configured to store a cargo, wherein the refrigeration unit is coupled to the container and configured to condition an environment within the container; wherein the refrigeration unit comprises a compressor, a condenser, and an evaporator, wherein the bypass cooling circuit is fluidly coupled between the evaporator and the compressor downstream of the evaporator; a heat exchanger thermally coupled between the bypass cooling circuit and the fuel cooling circuit; wherein the bypass cooling circuit comprises an inlet conduit and a return conduit fluidly coupled to the heat exchanger; wherein the bypass cooling circuit further comprises a bypass valve configured to selectively supply the refrigerant to the bypass cooling circuit; wherein the fuel cooling circuit comprises a fuel inlet conduit and a fuel return conduit fluidly coupled to the heat exchanger; wherein the fuel cooling circuit further comprises a bypass valve configured to selectively supply the fuel to the fuel cooling circuit; a controller programmed to selectively switch the bypass valve between a first condition and a second condition when at least one of a predetermined ambient temperature is exceeded and a predetermined fuel temperature is exceeded; and/or a first temperature sensor configured to sense a temperature of ambient air and a second temperature sensor configured to sense a temperature of the fuel.

In another aspect, a temperature controlled cargo container is provided. The container includes a plurality of walls defining an interior space configured to store a cargo, a refrigeration unit configured to circulate a refrigerant, and a bypass cooling circuit fluidly coupled to the refrigeration unit. The container further includes a power generation system operably coupled to the refrigeration unit, the power generation system including a fuel tank fluidly coupled to an engine, and a fuel cooling circuit fluidly coupled between the fuel tank and the engine. The fuel cooling circuit is thermally coupled to the bypass cooling circuit and is configured to cool a fuel by thermal exchange with the refrigerant.

In addition to one or more of the features described above, or as an alternative, further embodiments may include: wherein the refrigeration unit comprises a compressor, a condenser, and an evaporator, wherein the bypass cooling circuit is fluidly coupled between the evaporator and the compressor downstream of the evaporator; a heat exchanger thermally coupled between the bypass cooling circuit and the fuel cooling circuit; wherein the bypass cooling circuit comprises an inlet conduit and a return conduit fluidly coupled to the heat exchanger; wherein the bypass cooling circuit further comprises a bypass valve configured to selectively supply the refrigerant to the bypass cooling circuit; wherein the fuel cooling circuit comprises a fuel inlet conduit and a fuel return conduit fluidly coupled to the heat exchanger; wherein the fuel cooling circuit further comprises a bypass valve configured to selectively supply the fuel to the fuel cooling circuit; a controller programmed to selectively switch the bypass valve between a first condition and a second condition when at least one of a predetermined ambient temperature is exceeded and a predetermined fuel temperature is exceeded; and/or a first temperature sensor configured to sense a temperature of ambient air, and a second temperature sensor configured to sense a temperature of the fuel.

In yet another aspect, a method of fabricating a fuel cooling system is provided. The method includes providing a refrigeration unit configured to circulate a refrigerant, providing a bypass cooling circuit fluidly coupled to the refrigeration unit, and providing a power generation system operably coupled to the refrigeration unit, the power generation system including a fuel tank fluidly coupled to an engine. The method further includes providing a fuel cooling circuit fluidly coupled between the fuel tank and the engine, thermally coupling a heat exchanger between the bypass cooling circuit and the fuel cooling circuit to provide thermal exchange between the refrigerant and the fuel, and operably coupling a controller to the bypass cooling circuit and the fuel cooling circuit. The controller is programmed to selectively operate between a first mode and a second mode. In the first mode the refrigerant bypasses the bypass cooling circuit and the fuel bypasses the fuel cooling circuit, and in the second mode the refrigerant is circulated through the bypass cooling circuit and the fuel is circulated through the fuel cooling circuit.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of an exemplary cargo container having a fuel cooling system; and

FIG. 2 is a schematic view of an exemplary fuel cooling system that may be used with the cargo container shown in FIG. 1.

### DETAILED DESCRIPTION OF THE INVENTION

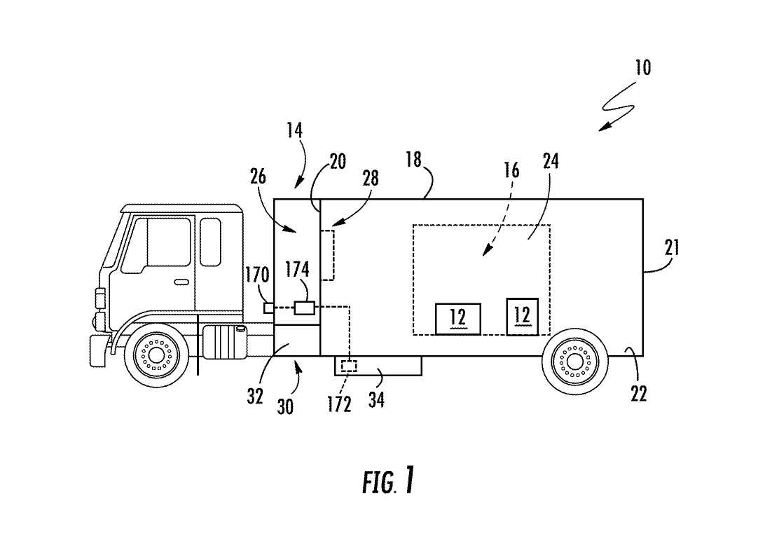

FIG. 1 illustrates a temperature controlled cargo container 10 configured to maintain a cargo 12 located inside the cargo container 10 at a selected temperature through the use of a temperature control unit 14. Cargo container 10 is utilized to transport cargo 12 via, for example, a truck, a train or a ship.

Container 10 generally includes an interior space 16 formed by thermally insulated walls including a top wall 18, a front wall 20, a rear wall 21, a floor 22, and side walls 24. Temperature control unit 14 is mounted at front wall 20. In the exemplary embodiment, temperature control unit 14 is a refrigeration unit that includes an exterior condenser 26 and an interior evaporator section 28. Refrigeration unit 14 is powered by a power generation system 30, which generally includes an engine 32 that is fluidly coupled to a fuel tank 34. Although described as a refrigeration unit, temperature control unit 14 may be any suitable environment conditioning system. For example, temperature control unit 14 may be a cab air conditioning unit for a truck.

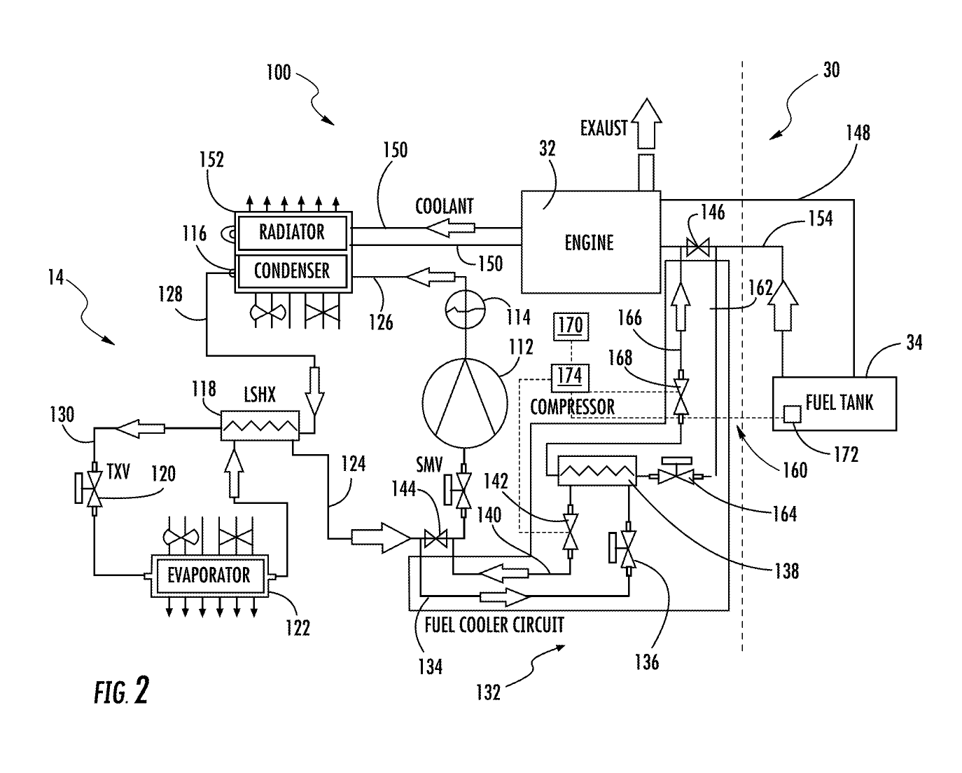

FIG. 2 is a schematic illustration of a fuel cooling system 100 that includes refrigeration unit 14 and power generation system 30.

Refrigeration unit 14 generally includes a compressor 112, a condenser 116, a liquid suction heat exchanger 118, an expansion valve 120, and an evaporator 122. In the exemplary embodiment, compressor 112 is a scroll or reciprocating type and evaporator 122 is a flooded-type evaporator. However, compressor 112 may be any suitable type of compressor (e.g., centrifugal), and evaporator 122 may be any suitable evaporator that enables unit 14 to function as described herein.

Refrigeration unit 14 is a closed loop system through which refrigerant is circulated in various states such as liquid and vapor. As such, a low temperature, low pressure superheated gas refrigerant is drawn into compressor 112 through a conduit 124 from evaporator 122. The refrigerant is compressed and the resulting high temperature, high pressure superheated gas is discharged from compressor 112 to condenser 116 through a conduit 126.

In condenser 116, gaseous refrigerant is condensed into liquid as it gives up heat. The superheated gas refrigerant enters condenser 116 and is de-superheated, condensed, and sub-cooled through a heat exchanger process with, for example, engine coolant flowing through condenser 116 (or thermally coupled heat exchanger) to absorb heat. However, condenser 116 may be air cooled or evaporatively cooled. The liquid refrigerant is discharged from condenser 116 and supplied through a conduit 128 to liquid suction heat exchanger 118.

In the exemplary embodiment, liquid suction heat exchanger 118 cools liquid refrigerant from condenser 116 against vaporized and/or vaporizing refrigerant from evaporator 122. The cooled liquid refrigerant is subsequently supplied to evaporator 122 through a conduit 130. The cooled liquid refrigerant passes through a metering device or expansion valve 120, which converts the relatively higher temperature, high pressure sub-cooled liquid to a low temperature saturated liquid-vapor mixture.

The low temperature saturated liquid-vapor refrigerant mixture then enters evaporator 122 where it boils and changes states to a superheated gas as it absorbs the required heat of vaporization from chilled water (or other heat exchange fluid). The low pressure superheated gas then passes in heat exchange relation with heat exchanger 118, where it is further heated to increase the superheat of the gas and vaporize any residual liquid droplets that may pass evaporator 122. The superheated gas is then drawn into the inlet of compressor 112 and the cycle is repeated.

In the exemplary embodiment, refrigeration unit 14 includes a bypass cooling circuit 132 that branches off from conduit 124 and generally includes an inlet conduit 134, a bypass valve 136, a heat exchanger 138, a return conduit 140, and a valve 142 (e.g., a check valve). A second bypass valve 144 may be disposed on conduit 124 between inlet conduit 134 and return conduit 140. When bypass valve 136 is closed (and second bypass valve 144 is open), refrigerant is supplied directly from heat exchanger 118 to compressor 112. When bypass valve 136 is open (and second bypass valve 144 is closed), refrigerant is supplied via inlet conduit 134 to heat exchanger 138 for thermal exchange with a fuel flowing through power generation system 30, as is described herein in more detail. The warmed refrigerant is then supplied via return conduit 140 to conduit 124 and back to compressor 112.

Power generation system 30 generally includes engine 32 fluidly coupled to fuel tank 34. A conduit 150 supplies a coolant between engine 32 and a heat exchanger 152 (e.g., a radiator) to cool engine 32 during operation. A fuel supply conduit 154 supplies a fuel (e.g., diesel fuel) to engine 32 for operation thereof, and any unused or unburnt fuel is returned to tank 34 via a fuel return conduit 148.

Power generation system 30 includes a fuel cooling circuit 160 that branches off from supply conduit 154 and generally includes an inlet conduit 162, a bypass valve 164, heat exchanger 138, a return conduit 166, and a valve 168 (e.g., a check valve). A second bypass valve 146 may be disposed on supply conduit 154 between inlet conduit 162 and return conduit 166. When bypass valve 164 is closed (and second bypass valve 146 is open), fuel is supplied directly from fuel tank 34 to engine 32. When bypass valve 164 is open (and second bypass valve 146 is closed), fuel is supplied via inlet conduit 162 to heat exchanger 138 where the fuel is subsequently cooled by thermal exchange with the refrigerant passing through bypass circuit 132. The cooled fuel is then supplied via return conduit 166 to engine 32. Alternatively, fuel cooling circuit 160 may branch off a return fuel conduit 148 from engine 32 to fuel tank 34.

As such, the cooled fuel supplied through fuel cooling circuit 160 facilitates increased engine efficiency and power, cleaner exhaust, and reduced fuel consumption.

Fuel cooling system 100 may include one or more sensors (e.g., temperature sensors) to determine when to utilize bypass circuit 132 and fuel cooling circuit 160 to cool fuel supplied to engine 32. For example, as illustrated, a first temperature sensor 170 senses the ambient temperature, and a second temperature sensor 172 senses the temperature of the fuel in fuel tank 34. A controller 174 may be in signal communication with sensors 170, 172 and bypass valves 136, 164. If a predetermined temperature is sensed by one of temperature sensors 170, 172, controller 174 may be programmed to open bypass valves 136 and 164 to commence cooling of fuel supplied to engine 32. For example, if the ambient temperature reaches a predetermined temperature, controller 174 may open bypass valves 136, 164. Alternatively, or in addition, if the fuel temperature reaches a predetermined temperature (e.g., an increased amount of warmed, unused fuel is returned to tank 34), controller 174 may open bypass valves 136, 164. As used herein, the term controller refers to an application specific integrated circuit (ASIC), an electronic circuit, a processor (shared, dedicated, or group) and memory that executes one or more software or firmware programs, a combinational logic circuit, and/or other suitable components that provide the described functionality.

Fuel cooling system 100 is configured to switch between a normal operation first mode and a fuel-cooling second mode. In the first mode, bypass valves 136, 164 are closed and valves 144, 146 are open such that bypass circuit 132 and fuel cooling circuit 160 are not utilized. At a predetermined time or after a predetermined condition, fuel cooling system 100 is switched to the second mode (e.g., by controller 174) and bypass valves 136, 164 are opened and valves 144, 146 are closed such that bypass circuit 132 and fuel cooling circuit 160 are utilized to cool fuel being supplied to engine 32.

Described herein are systems and methods for cooling a fuel used to operate an engine for a transport refrigeration unit. The system includes a refrigeration unit bypass circuit that is thermally coupled to a fuel cooling circuit attached to the engine. At a predetermined time, fuel is selectively supplied to the fuel cooling circuit to be cooled by refrigerant supplied to the bypass circuit. Cooling the fuel and its physical properties facilitates increased engine efficiency and power, cleaner exhaust, and reduced fuel consumption.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel cooling system comprising:
a refrigeration unit configured to circulate a refrigerant;
a bypass cooling circuit fluidly coupled to the refrigeration unit;
a power generation system operably coupled to the refrigeration unit, the power generation system including a fuel tank fluidly coupled to an engine; and
a fuel cooling circuit fluidly coupled between the fuel tank and the engine, the fuel cooling circuit thermally coupled to the bypass cooling circuit and configured to cool a fuel by thermal exchange with the refrigerant.

2. The system of claim 1, further comprising a container configured to store a cargo, wherein the refrigeration unit is coupled to the container and configured to condition an environment within the container.

3. The system of claim 1, wherein the refrigeration unit comprises a compressor, a condenser, and an evaporator, wherein the bypass cooling circuit is fluidly coupled between the evaporator and the compressor downstream of the evaporator.

4. The system of claim 1, further comprising a heat exchanger thermally coupled between the bypass cooling circuit and the fuel cooling circuit.

5. The system of claim 4, wherein the bypass cooling circuit comprises an inlet conduit and a return conduit fluidly coupled to the heat exchanger.

6. The system of claim 5, wherein the bypass cooling circuit further comprises a bypass valve configured to selectively supply the refrigerant to the bypass cooling circuit.

7. The system of claim 4, wherein the fuel cooling circuit comprises a fuel inlet conduit and a fuel return conduit fluidly coupled to the heat exchanger.

8. The system of claim 7, wherein the fuel cooling circuit further comprises a bypass valve configured to selectively supply the fuel to the fuel cooling circuit.

9. The system of claim 8, further comprising a controller programmed to selectively switch the bypass valve between a first condition and a second condition when at least one of a predetermined ambient temperature is exceeded and a predetermined fuel temperature is exceeded.

10. The system of claim 1, further comprising:
a first temperature sensor configured to sense a temperature of ambient air; and
a second temperature sensor configured to sense a temperature of the fuel.

11. A temperature controlled cargo container comprising:
a plurality of walls defining an interior space configured to store a cargo;
a refrigeration unit configured to circulate a refrigerant;
a bypass cooling circuit fluidly coupled to the refrigeration unit;
a power generation system operably coupled to the refrigeration unit, the power generation system including a fuel tank fluidly coupled to an engine; and
a fuel cooling circuit fluidly coupled between the fuel tank and the engine, the fuel cooling circuit thermally coupled to the bypass cooling circuit and configured to cool a fuel by thermal exchange with the refrigerant.

12. The container of claim 11, wherein the refrigeration unit comprises a compressor, a condenser, and an evaporator, wherein the bypass cooling circuit is fluidly coupled between the evaporator and the compressor downstream of the evaporator.

13. The container of claim 11, further comprising a heat exchanger thermally coupled between the bypass cooling circuit and the fuel cooling circuit.

14. The container of claim 13, wherein the bypass cooling circuit comprises an inlet conduit and a return conduit fluidly coupled to the heat exchanger.

15. The container of claim 14, wherein the bypass cooling circuit further comprises a bypass valve configured to selectively supply the refrigerant to the bypass cooling circuit.

16. The container of claim 13, wherein the fuel cooling circuit comprises a fuel inlet conduit and a fuel return conduit fluidly coupled to the heat exchanger.

17. The container of claim 16, wherein the fuel cooling circuit further comprises a bypass valve configured to selectively supply the fuel to the fuel cooling circuit.

18. The container of claim 17, further comprising a controller programmed to selectively switch the bypass valve between a first condition and a second condition when at least one of a predetermined ambient temperature is exceeded and a predetermined fuel temperature is exceeded.

19. The container of claim 11, further comprising:
a first temperature sensor configured to sense a temperature of ambient air; and
a second temperature sensor configured to sense a temperature of the fuel.

20. A method of fabricating a fuel cooling system, the method comprising:
providing a refrigeration unit configured to circulate a refrigerant;
providing a bypass cooling circuit fluidly coupled to the refrigeration unit;
providing a power generation system operably coupled to the refrigeration unit, the power generation system including a fuel tank fluidly coupled to an engine;
providing a fuel cooling circuit fluidly coupled between the fuel tank and the engine;
thermally coupling a heat exchanger between the bypass cooling circuit and the fuel cooling circuit to provide thermal exchange between the refrigerant and the fuel; and
operably coupling a controller to the bypass cooling circuit and the fuel cooling circuit, the controller programmed to selectively operate between a first mode and a second mode, wherein in the first mode the refrigerant bypasses the bypass cooling circuit and the fuel bypasses the fuel cooling circuit, and wherein in the second mode the refrigerant is circulated through the bypass cooling circuit and the fuel is circulated through the fuel cooling circuit.
